(19) United States
(12) Patent Application Publication
(10) Pub. No.: US 2009/0279628 A1
(43) Pub. Date: Nov. 12, 2009

(54) Transmission Power Control Method In Communication System Using Multiple Carriers And Radio Communication Device Using The Method

(76) Inventor: Naoyuki SAITOU, Kawasaki (JP)

Correspondence Address: HANIFY & KING PROFESSIONAL CORPORATION, 1055 Thomas Jefferson Street, NW, Suite 400, WASHINGTON, DC, 20007, US

(21) Appl. No.: 12/506,707

(22) Filed: Jul. 21, 2009

Related U.S. Application Data
(63) Continuation of application No. PCT/JP2007/000026, filed on Jan. 24, 2007.

(51) Int. Cl. H04B 1/02; H04L 27/00; H04L 27/28; H04B 1/04

(52) U.S. Cl. 375/260; 455/101; 375/295; 455/127.2

(57) ABSTRACT

A transmission power control method is employed in a communication system, which uses multiple carriers. A plurality of different modulation systems are allocated to a plurality of different frequency subcarriers. A signal amplitude gain corresponding to a predetermined power offset from an average signal power is provided to a corresponding frequency subcarrier for each of the modulation systems allocated to the plurality of different frequency subcarriers. Therefore, service area can be expanded and signal quality can be maintained at a high transmission capacity.

### CROSS-REFERENCE TO RELATED APPLICATIONS

This application is a continuation of International Application No. PCT/JP2007/000026, filed on Jan. 24, 2007, now pending, herein incorporated by reference.

### FIELD

The present invention relates to a transmission power control method in a communication system using multiple carriers and to a radio communication device using this method.

### BACKGROUND

In a communication system using multiple carriers, the effect of radio propagation interference is reduced by transmitting data by using a plurality of carrier waves (subcarriers). As a result, high-speed transmission can be realized.

In an OFDM system, which is an example of a communication system using multiple carriers, parallel transmission is performed in which a plurality of subcarriers in which data are arranged are orthogonal to each other.

In this case, if the phases of subcarriers match each other, a transmission peak power that is substantially higher than the average transmission power is generated. Where the transmission peak power is high, a signal level reaches a nonlinear and saturation region of a power amplifier, thereby generating nonlinear distortions and degrading the transmission signal.

A clipping technique is known by which a limitation is imposed in advance on an instantaneous maximum power of the signal to prevent it from reaching the nonlinear region (for example, Patent Document 1: Japanese Laid-open Patent Application No. 2002-44054, Patent Document 2: Japanese Laid-open Patent Application No. 2005-101975).

Because the maximum power value of a power amplifier is constant, the power limitation for peak suppression by clipping is set between the average power and maximum power of the signal.

However, where the average transmission power is raised to increase the efficiency of a high-output amplifier, the peak suppression threshold approaches an apparent average power value. In such a case, the degradation of transmitted signal quality increases. Conversely, where the average signal power is reduced, the efficiency of the power amplifier decreases. Thus, there is a mutually exclusive relationship between ensuring signal quality and increasing efficiency.

In other to enlarge a communication service area (space propagation range) of radio access, it is necessary to increase the transmission power. Moreover, the number of levels in a modulation system has to be increased to raise a data packet transmission capacity. In recent years, the increase in transmission capacity in a wider service area is needed to improve a wire broadband service.

### SUMMARY

Accordingly, it is an object of the present invention to provide a transmission power control method for a signal in a communication system using multiple carriers that ensures signal quality, while maintaining high efficiency of a high-output amplifier in the case of any modulation system that changes adaptively, in an OFDM or OFDMA system that performs multicarrier transmission and employs a multilevel QAM modulation system, and also to provide a radio communication device using such a method.

It is another object of the present invention to provide a transmission power control method for a signal in a communication system using multiple carriers that is capable of realizing at the same time the expansion of service area and the increase in transmission capacity of transmission signals, and also to provide a radio communication device using such a method.

The present invention that attains the above-described objects, relates to a transmission power control method in the communication system using multiple carriers and to a radio communication device using such a method, and in accordance with the present invention, a plurality of different modulation systems are allocated to a plurality of different frequency subcarriers. Furthermore, a signal amplitude gain corresponding to a predetermined power offset from an average signal power is provided to a corresponding frequency subcarrier for each of the modulation systems allocated to the plurality of different frequency subcarriers.

The signal power is thus controlled adaptively to the modulation system. Therefore, a large power offset amount is provided to a modulation system with a small number of levels, high-amplification can be performed, and service area can be expanded. Furthermore, a smaller power offset amount can be provided to a modulation system with a large number of levels and signal quality can be maintained at a high transmission capacity.

When a transmission data packet and a pilot signal corresponding to the transmission data packet are transmitted by the plurality of different subcarriers, a transmission power of the pilot signal is individually offset by a constant amount according to a modulation system of the data packet. As a result, the amplitude gain can be controlled by matching the pilot signal information with a modulation index of symbol data.

Furthermore, an offset amount of transmission power may be changed according to a transmission ratio of the same modulation system for all the transmission signals.

In a method for controlling transmission power when a radio signal is transmitted using multiple carriers by using an orthogonal frequency division multiplexing system, power control of a predetermined amount corresponding to a modulation system is performed such that, in comparison with an average power of a first signal group corresponding to a first modulation system (for example, QPSK), which is obtained when the first signal group is subjected to inverse Fourier transformation and transformed into a signal of a time region, an average power of a second signal group corresponding to a second modulation system (for example, 16QAM or 64QAM) that has a modulation index larger than that of the first modulation system, which is obtained when the second signal group is subjected to inverse Fourier transformation and transformed into a signal of a time axis, becomes smaller.

In the first modulation system and the second modulation system, the transmission can be performed synchronously or in different time intervals.

Furthermore, in a radio communication device for transmitting a radio signal using multiple carriers by using an orthogonal frequency division multiplexing system, there is provided a power control unit that performs power control of a predetermined amount corresponding to a modulation system such that, in comparison with an average power of a first signal group corresponding to a first modulation system, which is obtained when the first signal group is subjected to inverse Fourier transformation and transformed into a signal of a time region, an average power of a second signal group corresponding to a second modulation system that has a modulation index larger than that of the first modulation system, which is obtained when the second signal group is subjected to inverse Fourier transformation and transformed into a signal of a time axis, becomes smaller.

In the first modulation system and the second modulation system, the transmission can be performed synchronously or in different time intervals.

### BRIEF DESCRIPTION OF DRAWINGS

FIG. 1 is a block-diagram illustrating a configuration example of a radio communication device employing the transmission power control method in accordance with the present invention;

FIG. 2 is an explanatory diagram of the input-output characteristic of the power amplifier 9 and linear compensation processing of the nonlinear region;

FIG. 3A illustrates that a level of the OFDM signal symbol inputted in the transmission power adjustment unit is constant, regardless of the modulation system;

FIG. 3B illustrates that the transmission power adjustment unit controls the signal amplitude gain so as to provide a predetermined power offset value to the average signal power according to the modulation system.

FIG. 4 is a block diagram of a schematic configuration of the first embodiment of the transmission power adjustment unit;

FIG. 5 is a block diagram of a schematic configuration of the second embodiment of the transmission power adjustment unit; and

FIG. 6 is a block diagram of a schematic configuration of the third embodiment of the transmission power adjustment unit.

### DESCRIPTION OF EMBODIMENTS

Embodiments will now be described with reference to the drawings. The same symbols are attached to the similar or same reference numbers as possible the same reference numerals in the drawings are used to denote and identify corresponding or identical components.

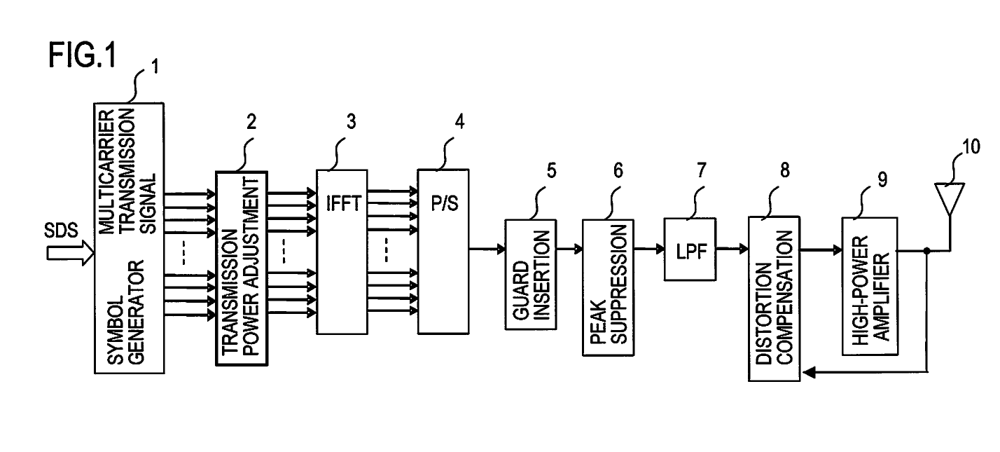

FIG. 1 is a block-diagram illustrating a configuration example of a radio communication device employing the transmission power control method in accordance with an embodiment. In particularly, this figure illustrates a configuration of transmission device directly relating to the embodiment in a radio base station.

An inputted multicarrier transmission signal SDS is inputted in a symbol data generation unit 1. In the symbol data generation unit 1, a data symbol corresponding to the inputted multicarrier transmission signal SDS is generated and divided in frequency directions.

The data symbol is then inputted in a transmission power adjustment unit 2, which is a specific feature of the embodiment. In the transmission power adjustment unit 2, the transmission power of the signal is offset by a constant amount from an average signal power according to variation of a modulation system (BPSK, QPSK, 16QAM, 640QAM, etc.) of the transmitted signal, as will be described hereinbelow in greater detail. For example, offset control is performed to reduce the average power of the signal corresponding to 16QAM so that the average signal power of the signal corresponding to the 16QAM decreases with respect to the average signal power of the signal corresponding to QPSK. In this case, the offset control may be also performed with respect to a signal corresponding to QPSK, and the control used is such that eventually the average signal power for 16QAM decreases.

When a processing is included that normalizes the average power according to the modulation system, the offset can be provided after the normalization.

An IFFT (inverse Fourier transform) unit 3 performs inverse Fourier transform with respect to the signal obtained by offsetting the transmission power by a constant amount and transforms the signal in the frequency axis direction into a signal in the time axis direction.

An IFFT sample signal after inverse Fourier transform is converted into a serial signal with a parallel/serial converter 4 and outputted continuously with time in sample units.

In this case, as a specific feature of the OFDM and OFDMA, a sample signal of a data guard band time is added to the sample signal after the IFFT in a guard insertion unit 5 to obtain a single OFDM signal symbol.

A peak suppression processing for restricting the instantaneous maximum power is then performed in a peak suppression unit 6 so that the power of the radio transmission does not exceed the limit of the maximum signal power of a high-output power amplifier 9.

Components outside the transmission signal band are then cut off with a low-pass filter 7.

The output of the low-pass filter 7 is subjected to feedback processing with a distortion compensation unit 8 to compensate linearly a nonlinear region of the high-output power amplifier 9 and increase power and then sent to an antenna 10.

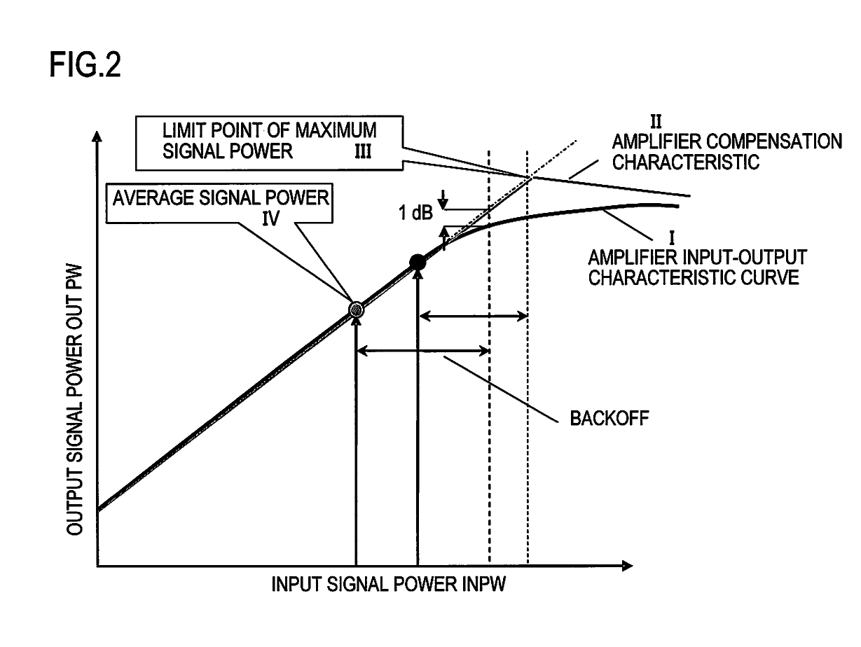

The input-output characteristic of the power amplifier 9 and linear compensation processing of the nonlinear region will be explained below with reference to FIG. 2.

In FIG. 2, the reference symbol I stands for an input-output characteristic curve of the power amplifier 9. The output vs. input signal power relationship is linear within a range before the input signal power reaches a constant value. Once this region is exceeded, the output reaches saturation.

Linearity is improved, as shown by an amplifier compensation characteristic II, by compensation performed by feedback processing in the distortion compensation unit 8 with respect to the input-output characteristic curve I, but there is a limit point III of the maximum signal power that is the limit of compensation.

Accordingly, in order to increase the efficiency in output power of the power amplifier 9, it is in principle necessary to raise an average signal power IV. However, where the average signal power IV is increased to a level of the average signal power v, when the instantaneous maximum power of the transmitted signal is high, a probability of exceeding the maximum signal power limit point III and entering the nonlinear region increases. As a result, the distortion component rises and signal quality is degraded.

Therefore, in accordance with the embodiment, in order to overcome this drawback, the transmission power adjustment unit 2 is provided with respect to a plurality of different transmission symbols (a plurality of different modulation systems are allocated to different frequency subcarriers at the same time) as a pre-processing of the IFFT unit 3 in the configuration example of the radio communication device in accordance with the present invention that is shown in FIG. 1. This transmission power adjustment unit 2 provides a gain of signal amplitude corresponding to the amount of power offset from the average signal power for each modulation system.

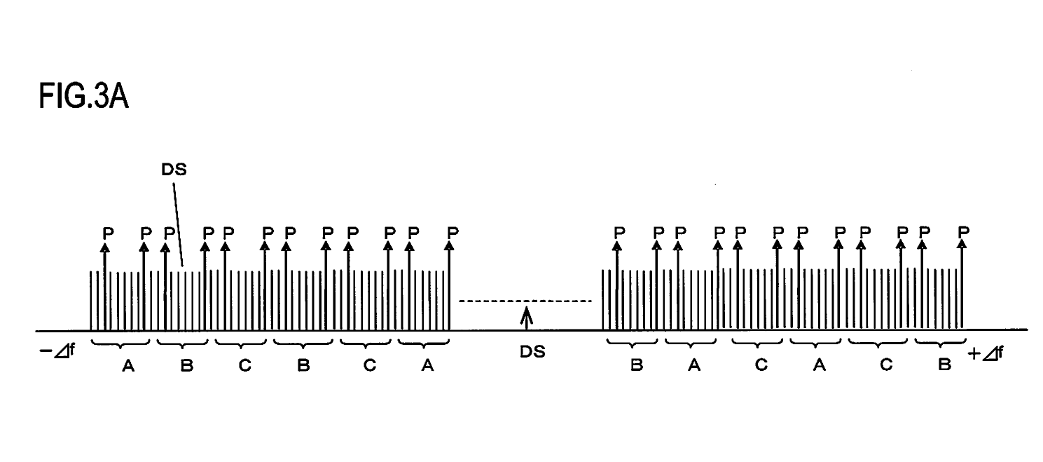

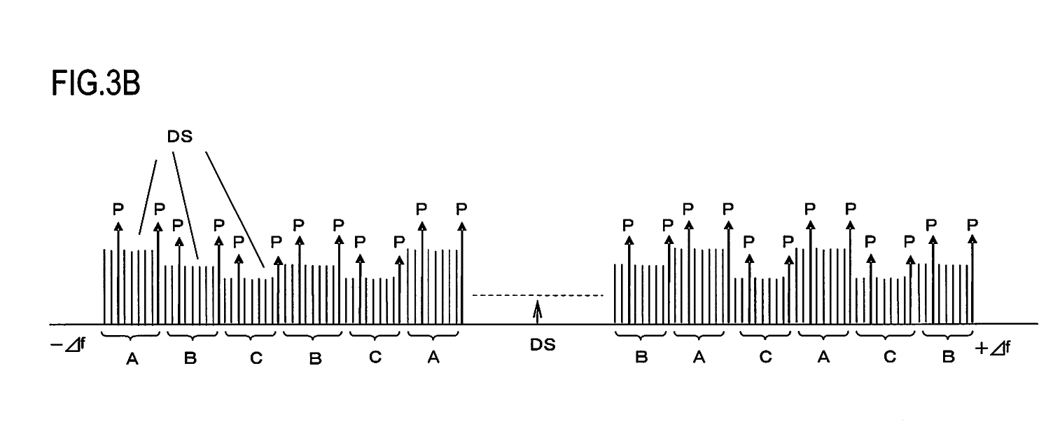

The operation principle of the transmission power adjustment unit 2 will be explained below with reference to FIG. 3A and FIG. 3B.

The radio communication device corresponds to an adaptive modulation system and is assumed to have QPSK (quadrature phase shift keying), 16-level QAM (quadrature amplitude modulation), and 64-level QAM as a modulation system employed according to the state of the user on the reception side.

A specific feature of these modulation systems is that the volume of transmitted information increases and noise resistance decreases (the number of levels of the signals to be modulated increases and, therefore, the distance between signal points in a phase plane decreases) in the order of QPSK, 16-level QAM, and 64-level QAM.

In FIG. 3A and FIG. 3B, data symbols allocated correspondingly to each divided frequency in a transmission frequency band (−Δf to +Δf) become OFDM signal symbols determined by a respective modulation system: QPSK (example of a first signal group), 16-level QAM (example of a second signal group), and 64-level QAM.

A, B, and C correspond to OFDM signal symbols of QPSK, 16-level QAM, and 64-level QAM, respectively, and an OFDM signal symbol has a data subcarrier DS and a pilot subcarrier P thereof. In this case, the difference in level between the pilot subcarrier P and the data subcarrier DS is a certain constant value.

FIG. 3A illustrates that a level of the OFDM signal symbol inputted in the transmission power adjustment unit 2 is constant, regardless of the modulation system.

By contrast, in accordance with the embodiment, as illustrated in FIG. 3B, the transmission power adjustment unit 2 controls the signal amplitude gain so as to provide a predetermined power offset value to the average signal power according to the modulation system.

Thus, with respect to the data subcarrier DS of the OFDM signal symbol A that is QPSK, which is the modulation system with the lowest number of levels, and the pilot subcarrier P thereof, a signal amplitude gain is provided that corresponds to the power offset such that the signal power increases with respect to the average signal power IV. As a result, the transmission power of the data increases and a cell of a signal arrival range can be expanded.

On the other hand, where the number of levels of the modulation system increases, the effect of noise becomes visible. Therefore, a signal amplitude gain is provided that corresponds to the power offset such that the signal power decreases by comparison with that of the QPSK modulation system. In this case, the signal power may be less than the average signal power IV, provided that it is within a range allowed by amplifier efficiency.

With such a control method in accordance with the embodiment, high efficiency of the high-output amplifier can be maintained with any of the adaptively changed modulation system, and significant deterioration of signal quality is prevented. Furthermore, the expansion of service area and increase in transmission capacity of transmission signals can be realized at the same time.

A configuration example of the transmission power adjustment unit 2 will be explained below.

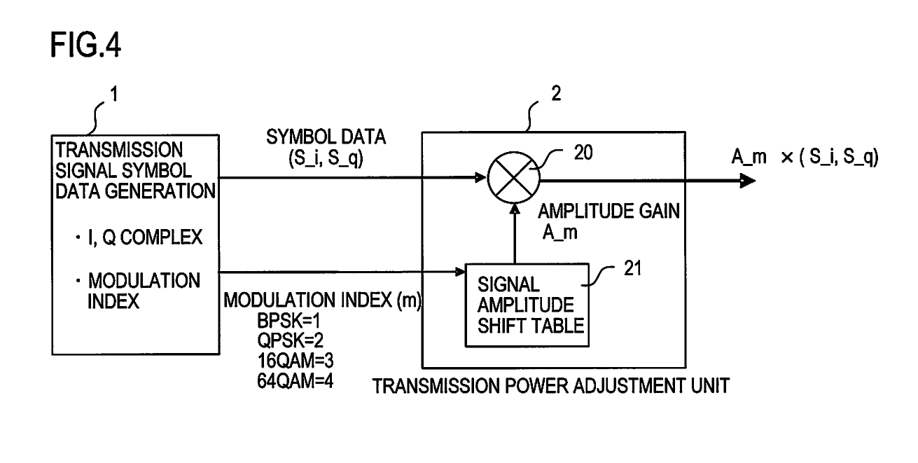

FIG. 4 is a block diagram of a schematic configuration of the first example of the transmission power adjustment unit 2.

Transmission data outputted from the symbol data generation unit 1 of a transmission signal are inputted as orthogonal (I, Q) complex signals (S_i, S_q) to the transmission power adjustment unit 2.

These I, Q complex signals are assumed to have amplitude information as I, Q orthogonal vectors in an orthogonal phase plane. Information of the modulation system of corresponding symbol data is inputted at the same time as a modulation index (m).

The modulation index (m) is set in advance so that, for example, BPSK: m=1, QPSK: m=2, 16QAM: m=3, and 64QAM: m=4, according to the modulation system use.

The transmission power adjustment unit 2 has a multiplier 20 and a signal amplitude shift table 21 based on a ROM. The signal amplitude shift table 21 holds an amplitude gain coefficient A_m corresponding to the modulation index (m) as a corresponding value.

Therefore, in response to the inputted modulation index (m), an amplitude gain (A_m) corresponding to a respective signal power shift amount is read with reference to the table 21. Output data A_m×(S_i, S_q) are obtained by multiplying the amplitude gain (A_m) that has been read out by an input symbol data (S_i, S_q) in the multiplier 20.

As a result, any amplitude gain can be provided based on the difference in modulation systems.

Because the amplitude gain of symbol data is controlled in the power amplifier 9 correspondingly to the modulation system, as described hereinabove, a power offset corresponding to the control of amplitude gain is provided to the average signal power and an amplification operation of high efficiency can be performed.

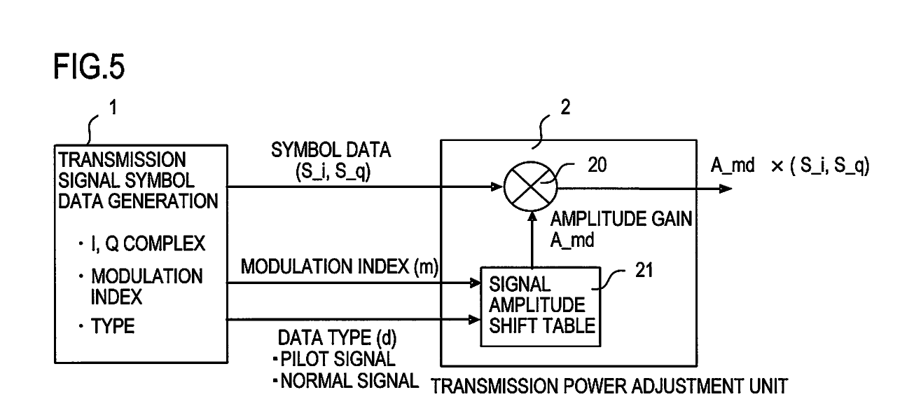

FIG. 5 is a block diagram of a schematic configuration of the second example of the transmission power adjustment unit 2.

In the example illustrated in FIG. 5, a configuration is used in which an amplitude gain (A_md) is obtained by combining information (d) of a pilot signal for symbol data corresponding to the usual user information with a modulation index (m) of symbol data.

Thus, in the example illustrated in FIG. 5, the amplitude gain (A_md) is tabulated in the signal amplitude shift table 21 correspondingly to a combination of the modulation index (m) and data type (d) demarcating either a pilot signal P or a signal of normal data carrier DS.

Therefore, the amplitude gain (A_md) is found from the signal amplitude shift table 21 on the basis of modulation index (m) and data type (d) and multiplied by the input symbol data (S_i, S_q) in the multiplier 20. As a result, output data A_m×(S_i, S_q) are obtained.

Thus, any amplitude gain can be provided correspondingly to the difference in modulation system and whether a data pilot or a data channel is employed.

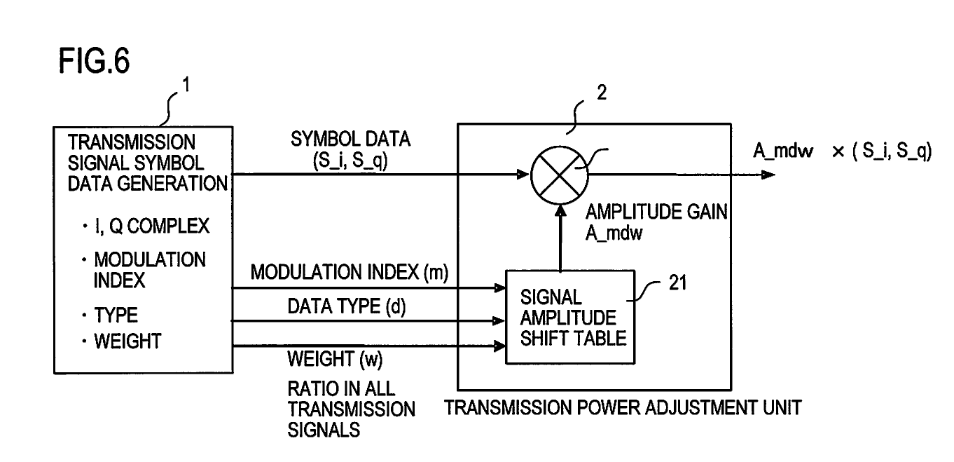

FIG. 6 is a block diagram of a schematic configuration of the third example of the transmission power adjustment unit 2.

In the example shown in FIG. 6, a ratio of the same modulation system in all the signals transmitted at the same time is used as weight (w) information in the configuration of the example shown in FIG. 5 and an amplification gain (A_mdw) is obtained.

As for the ratio of the same modulation system in all the signals, the ratio of the same modulation system changes depending on the communication parties, more specifically on the reception sensitivity notified from a moving station, and the weight (w) information is determined correspondingly to this change.

As described hereinabove based on examples, the present invention makes it possible to ensure signal quality, while maintaining high efficiency of a high-output amplifier in the case of any modulation system that changes adaptively, increases reliability of a communication system, and makes significant contribution to the industry.

The present embodiment is therefore to be considered in all respects as illustrative and not restrictive, the scope of the invention being indicated by the appended claims rather than by the foregoing description and all changes with come within the meaning and range of equivalency of the claims are therefore intended too be embraced therein.

What is claimed is:

1. A transmission power control method in a communication system using multiple carriers, the method comprising:
allocating a plurality of different modulation systems to a plurality of different frequency subcarriers; and
providing a signal amplitude gain corresponding to a predetermined power offset from an average signal power to a corresponding frequency subcarrier for each of the modulation systems allocated to the plurality of different frequency subcarriers.

2. The transmission power control method according to claim 1, wherein
the plurality of different modulation systems are multilevel modulation systems in which signal points are arranged in a phase space, and
in the step of providing the signal amplitude gain, the predetermined power offset from the average signal power is made largest for a modulation system with the smallest number of levels from among the plurality of different modulation systems.

3. The transmission power control method according to claim 1, wherein
in the step of providing the signal amplitude gain, when a transmission data packet and a pilot signal corresponding to the transmission data packet are transmitted by the plurality of different subcarriers, a transmission power of the pilot signal is individually offset by a constant amount according to a modulation system of the data packet.

4. The transmission power control method according to claim 1, wherein
in the step of providing the signal amplitude gain, an offset amount of transmission power is changed according to a transmission ratio of the same modulation system for all the transmission signals.

5. A radio communication device using multiple carriers, comprising:
a data symbol generation unit to generate data symbols divided in a frequency direction correspondingly to a transmitted signal; and
a transmission power adjustment unit to provide an amplitude gain corresponding to an offset amount from an average signal power provided to a transmission power in a power amplifier to a subcarrier amplitude for each of a plurality of different modulation systems for the generated data symbols.

6. The radio communication device according to claim 5, wherein
the modulation systems for the data symbols are multilevel modulation systems in which signal points are arranged in a phase space, and
the transmission power adjustment unit provides an amplitude gain such that a predetermined power offset from the average signal power is made largest for a modulation system with the smallest number of levels from among the plurality of different modulation systems.

7. The radio communication device according to claim 5, wherein
the transmission power adjustment unit offsets a transmission power of the pilot signal individually by a constant amount according to a modulation system of the data packet, when transmission data packets and pilot signals corresponding to the respective transmission data packets are transmitted by a plurality of different subcarriers.

8. The radio communication device according to claim 5, wherein
the transmission power adjustment unit changes an offset amount of transmission power according to a transmission ratio of the same modulation system for all the transmission signals.

9. A method for controlling transmission power when a radio signal is transmitted using multiple carriers by using an orthogonal frequency division multiplexing system, wherein
power control of a predetermined amount corresponding to a modulation system is performed such that
in comparison with an average power of a first signal group corresponding to a first modulation system, which is obtained when the first signal group is subjected to inverse Fourier transformation and transformed into a signal of a time region,
an average power of a second signal group corresponding to a second modulation system that has a modulation index larger than that of the first modulation system, which is obtained when the second signal group is subjected to inverse Fourier transformation and transformed into a signal of a time axis, becomes smaller.

10. A radio communication device for transmitting a radio signal using multiple carriers by using an orthogonal frequency division multiplexing system, the radio communication device comprising:
a power control unit to perform power control of a predetermined amount corresponding to a modulation system such that;
in comparison with an average power of a first signal group corresponding to a first modulation system, which is obtained when the first signal group is subjected to inverse Fourier transformation and transformed into a signal of a time region, an average power of a second signal group corresponding to a second modulation system that has a modulation index larger than that of the first modulation system, which is obtained when the second signal group is subjected to inverse Fourier transformation and transformed into a signal of a time axis, becomes smaller.
